(19) United States
(12) Patent Application Publication
(10) Pub. No.: US 2011/0040480 A1
(43) Pub. Date: Feb. 17, 2011

(54) Navigation device and method for displaying a static image of an upcoming location along a route of travel

(75) Inventor: James Tebbutt, Amsterdam (NL)

Correspondence Address: Harness, Dickey & Pierce P.L.C., P.O. Box 8910, Reston, VA, 20195, US

(73) Assignee: Tom Tom International B.V., Amsterdam (NL)

(21) Appl. No.: 12/736,345

(22) PCT Filed: May 2, 2008
(86) PCT No.: PCT/EP2008/003713

§ 371 Date: Sep. 30, 2010

(51) Int. Cl. G01C 21/34; G01C 21/36

(52) U.S. Cl. 701/211

(57) ABSTRACT

A method and device are disclosed for navigation. In at least one embodiment, the method includes determining map information for display on an integrated input and display device of a navigation device, based upon a determined route of travel of the navigation device; displaying the determined map information, in three dimensions on the integrated input and display device of the navigation device; and displaying, along with the determined map information, a static image of a location along the determined route of travel on the integrated input and display device of the navigation device when the navigation device is determined to be within a threshold distance of the location. In at least one embodiment, the navigation device includes a processor to determine map information for subsequent display, based upon a determined route of travel of the navigation device, and being useable to control display of at least a portion of the map information; and an integrated input and display device to display the map information; the processor is further useable to control display of a static image of a location along the determined route of travel on the integrated input and display device simultaneously with the display of the map information when the navigation device is determined to be within a threshold distance of the location.

### FIELD

The present application generally relates to navigation methods and devices.

### BACKGROUND

Navigation devices were traditionally utilized mainly in the areas of vehicle use, such as on cars, motorcycles, trucks, boats, etc. Alternatively, if such navigation devices were portable, they were further transferable between vehicles and/or useable outside the vehicle, for foot travel for example.

These devices are typically tailored to produce a route of travel based upon an initial position of the navigation device and a selected/input travel destination (end position), noting that the initial position could be entered into the device, but is traditionally calculated via GPS Positioning from a GPS receiver within the navigation device. To aid in navigation of the route, map information is visually output along the route of travel to a user of the navigation device.

### SUMMARY

The inventors discovered that it may be beneficial to display, for a user of a navigation device, a static image of an upcoming location along a predetermined route of travel. Replacing the standard map information with a static image of such an upcoming location may cause the user of the navigation device some difficulty, inconvenience, disorientation, or discomfort. Thus, the inventors have, in at least one embodiment, devised a method, device and/or computer readable medium for displaying a static image of an upcoming location along a route of travel without depriving the user of the standard map information.

In at least one embodiment of the present application, a method includes determining map information for display on an integrated input and display device of a navigation device, based upon a determined route of travel of the navigation device; displaying the determined map information, in three dimensions on the integrated input and display device of the navigation device; and displaying, along with the determined map information, a static image of a location along the determined route of travel on the integrated input and display device of the navigation device when the navigation device is determined to be within a threshold distance of the location.

In at least one embodiment of the present application, a navigation device includes a processor to determine map information for subsequent display, based upon a determined route of travel of the navigation device, and being useable to control display of the map information; and an integrated input and display device to display the map information; the processor being further useable to control display of a static image of a location along the determined route of travel on the integrated input and display device simultaneously with the display of the map information when the navigation device is determined to be within a threshold distance of the location.

### BRIEF DESCRIPTION OF THE DRAWINGS

The present application will be described in more detail below by using example embodiments, which will be explained with the aid of the drawings, in which:

FIG. 1 illustrates an example view of a Global Positioning System (GPS);

FIG. 2 illustrates an example block diagram of electronic components of a navigation device of an embodiment of the present application;

FIG. 3 illustrates an example block diagram of a server, navigation device and connection therebetween of an embodiment of the present application;

FIGS. 4A and 4B are perspective views of an implementation of an embodiment of the navigation device 200;

FIG. 5 illustrates an example of a display of a static image of a location along a route of travel.

FIG. 6 illustrates an example of a display of an embodiment of the present application.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the term “and/or” includes any and all combinations of one or more of the associated listed items.

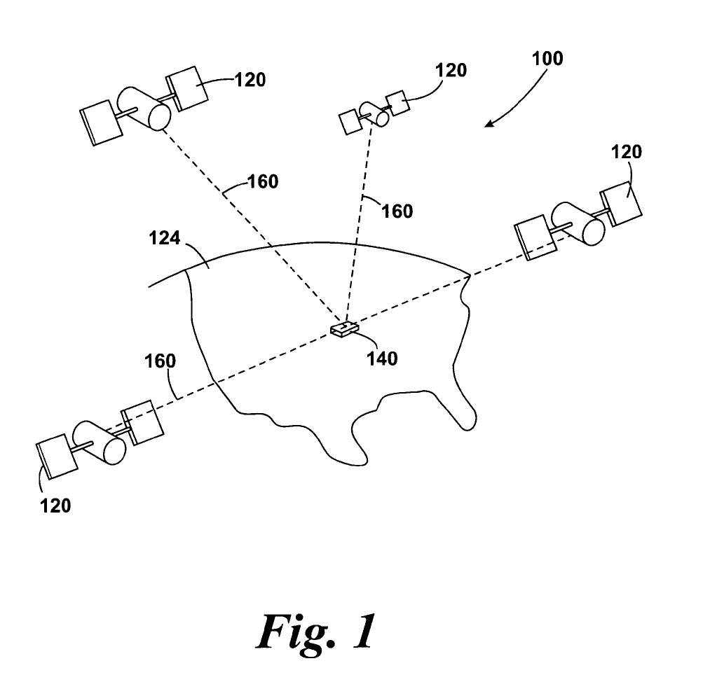

FIG. 1 illustrates an example view of Global Positioning System (GPS), usable by navigation devices, including the navigation device of embodiments of the present application. Such systems are known and are used for a variety of purposes. In general, GPS is a satellite-radio based navigation system capable of determining continuous position, velocity, time, and in some instances direction information for an unlimited number of users.

Formerly known as NAVSTAR, the GPS incorporates a plurality of satellites which work with the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140, usable in embodiments of navigation devices of the present application, is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

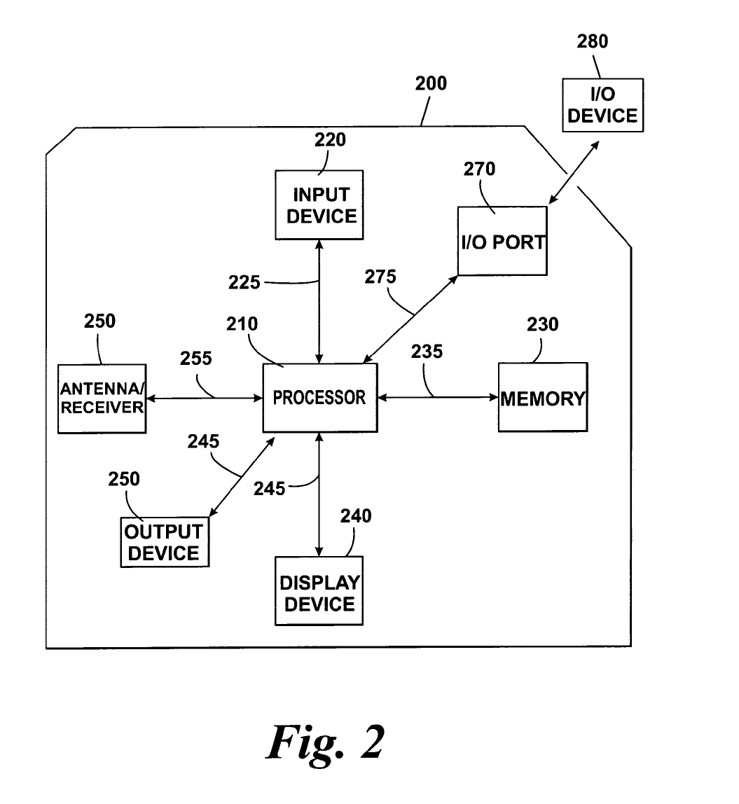

FIG. 2 illustrates an example block diagram of electronic components of a navigation device 200 of an embodiment of the present application, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilized to input information; and the display screen 240 can include any type of display screen such as an LCD display, for example. In at least one embodiment of the present application, the input device 220 and display screen 240 are integrated into an integrated input and display device, including a touchpad or touchscreen input wherein a user need only touch a portion of the display screen 240 to select one of a plurality of display choices or to activate one of a plurality of virtual buttons.

In addition, other types of output devices 250 can also include, including but not limited to, an audible output device. As output device 250 can produce audible information to a user of the navigation device 200, it is equally understood that input device 240 can also include a microphone and software for receiving input voice commands as well.

In the navigation device 200, processor 210 is operatively connected to and set to receive input information from input device 240 via a connection 225, and operatively connected to at least one of display screen 240 and output device 250, via output connections 245, to output information thereto. Further, the processor 210 is operatively connected to memory 230 via connection 235 and is further adapted to receive/send information from/to input/output (I/O) ports 270 via connection 275, wherein the I/O port 270 is connectible to an I/O device 280 external to the navigation device 200. The external I/O device 270 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

The navigation device 200, in at least one embodiment, may establish a “mobile” network connection with the server 302 via a mobile device 400 (such as a mobile phone, PDA, and/or any device with mobile phone technology) establishing a digital connection (such as a digital connection via known Bluetooth technology for example). Thereafter, through its network service provider, the mobile device 400 can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device 400 (via a service provider) and another device such as the server 302, using the internet 410 for example, can be done in a known manner. This can include use of TCP/IP layered protocol for example. The mobile device 400 can utilize any number of communication standards such as CDMA, GSM, WAN, etc.

As such, an internet connection may be utilized which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet.

The navigation device 200 can further complete a data connection with the mobile device 400, and eventually with the internet 410 and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, wherein the internal antenna of the navigation device 200 can further alternatively be used). The mobile phone technology within the navigation device 200 can include internal components as specified above, and/or can include an insertable card, complete with necessary mobile phone technology and/or an antenna for example. As such, mobile phone technology within the navigation device 200 can similarly establish a network connection between the navigation device 200 and the server 302, via the internet 410 for example, in a manner similar to that of any mobile device 400.

For GRPS phone settings, the Bluetooth enabled device may be used to correctly work with the ever changing spectrum of mobile phone models, manufacturers, etc., model/manufacturer specific settings may be stored on the navigation device 200 for example. The data stored for this information can be updated in a manner discussed in any of the embodiments, previous and subsequent.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered within the scope of the present application. For example, in one embodiment, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a motorized vehicle such as a car or boat for example. Such a navigation device 200 is then removable from the docked location for portable or handheld navigation use.

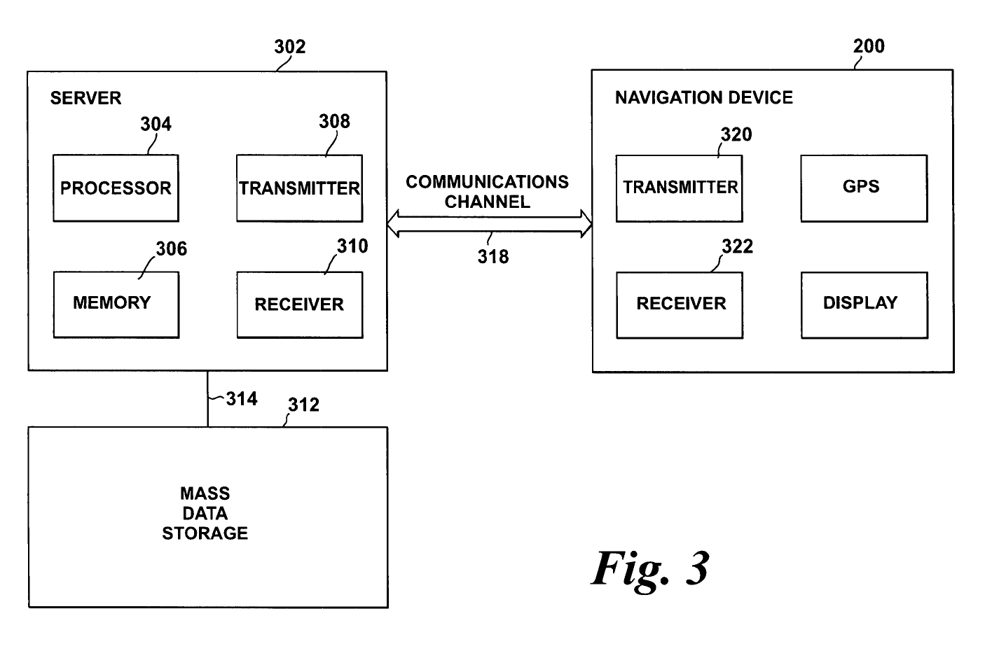

FIG. 3 illustrates an example block diagram of a server 302 and a navigation device 200 of the present application, via a generic communications channel 318, of an embodiment of the present application. The server 302 and a navigation device 200 of the present application can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. According to at least one embodiment of the present application, another service provided by the server 302 includes processing the navigation data using various algorithms for a desired application and sending the results of these calculations to the navigation device 200.

The communication channel 318 generically represents the propagating medium or path that connects the navigation device 200 and the server 302. According to at least one embodiment of the present application, both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, according to at least one embodiment, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fiber optic cables, converters, radio-frequency (rf) waves, the atmosphere, empty space, etc. Furthermore, according to at least one various embodiment, the communication channel 318 can include intermediate devices such as routers, repeaters, buffers, transmitters, and receivers, for example.

In at least one embodiment of the present application, for example, the communication channel 318 includes telephone and computer networks. Furthermore, in at least one embodiment, the communication channel 318 may be capable of accommodating wireless communication such as radio frequency, microwave frequency, infrared communication, etc. Additionally, according to at least one embodiment, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. According to at least one embodiment, these signals may be modulated, encrypted and/or compressed signals as may be desirable for the communication technology.

The mass data storage 312 includes sufficient memory for the desired navigation applications. Examples of the mass data storage 312 may include magnetic data storage media such as hard drives for example, optical storage media such as CD-Roms for example, charged data storage media such as flash memory for example, molecular memory, etc.

According to at least one embodiment of the present application, the server 302 includes a remote server accessible by the navigation device 200 via a wireless channel. According to at least one other embodiment of the application, the server 302 may include a network server located on a local area network (LAN), wide area network (WAN), virtual private network (VPN), etc.

According to at least one embodiment of the present application, the server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

The mass storage device 312 connected to the server 302 can include volumes more cartographic and route data than that which is able to be maintained on the navigation device 200 itself, including maps, etc. The server 302 may process, for example, the majority of the devices of a navigation device 200 which travel along the route using a set of processing algorithms. Further, the cartographic and route data stored in memory 312 can operate on signals (e.g. GPS signals), originally received by the navigation device 200.

As indicated above in FIG. 2 of the application, a navigation device 200 of an embodiment of the present application includes a processor 210, an input device 220, and a display screen 240. In at least one embodiment, the input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 240, such as audio input/output devices for example.

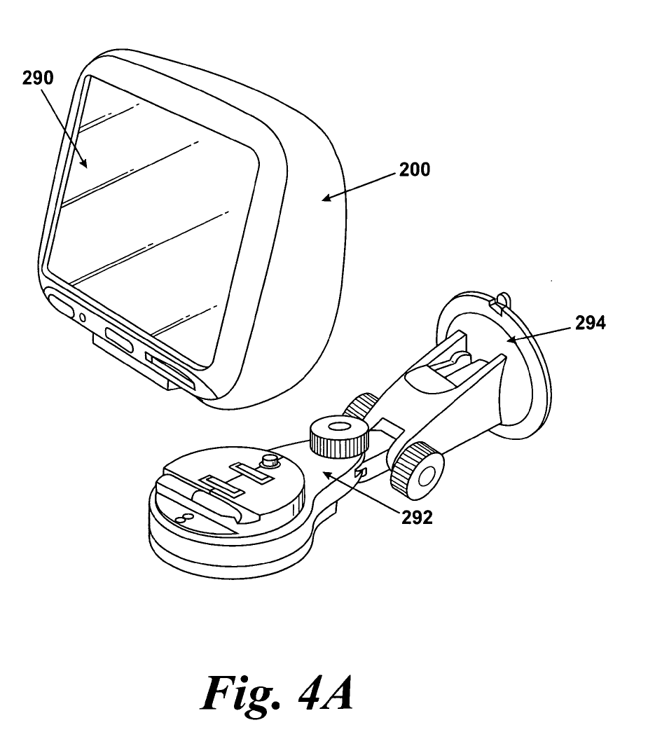

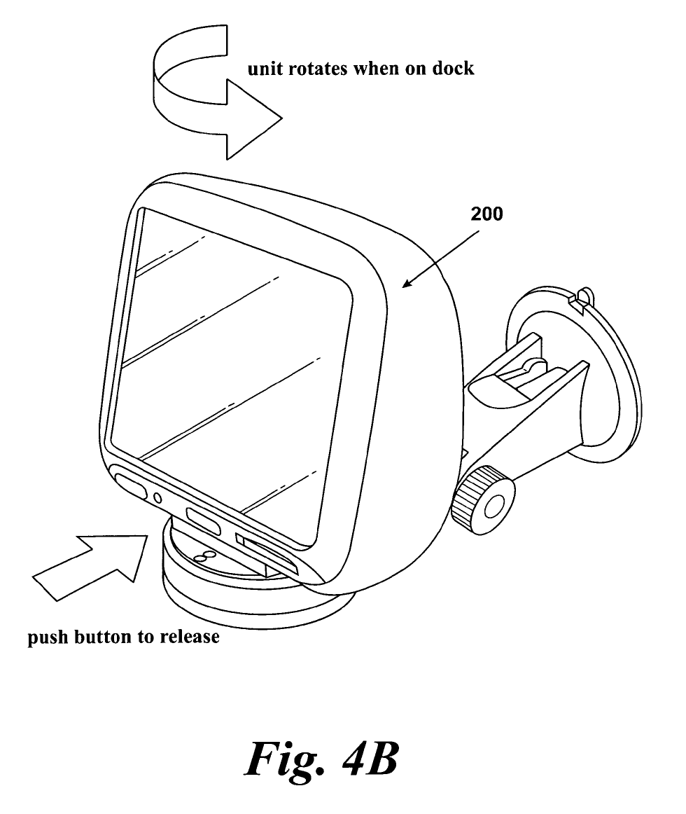

FIGS. 4A and 4B are perspective views of an implementation of an embodiment of the navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 230, etc.).

The navigation device 200 may sit on an arm 292, which itself may be secured to a vehicle dashboard/window/etc. using a large suction cup 294. This arm 292 is one example of a docking station to which the navigation device 200 can be docked.

As shown in FIG. 4B, the navigation device 200 can be docked or otherwise connected to an arm 292 of the docking station by snap connecting the navigation device 292 to the arm 292 for example (this is only one example, as other known alternatives for connection to a docking station are within the scope of the present application). The navigation device 200 may then be rotatable on the arm 292, as shown by the arrow of FIG. 4B. To release the connection between the navigation device 200 and the docking station, a button on the navigation device 200 may be pressed, for example (this is only one example, as other known alternatives for disconnection to a docking station are within the scope of the present application).

In at least one embodiment of the present application, a method includes determining map information for display on an integrated input and display device 290 of a navigation device 200, based upon a determined route of travel of the navigation device 200; displaying the determined map information, in three dimensions on the integrated input and display device 290 of the navigation device 200; and displaying, along with the determined map information, a static image of a location along the determined route of travel on the integrated input and display device 290 of the navigation device 200 when the navigation device 200 is determined to be within a threshold distance of the location.

In at least one embodiment of the present application, a navigation device 200 includes a processor 210 to determine map information for subsequent display, based upon a determined route of travel of the navigation device 200, and being useable to control display of the map information; and an integrated input and display device 290 to display the map information; the processor 210 being further useable to control display of a static image of a location along the determined route of travel on the integrated input and display device 290 simultaneously with the display of the map information when the navigation device 200 is determined to be within a threshold distance of the location.

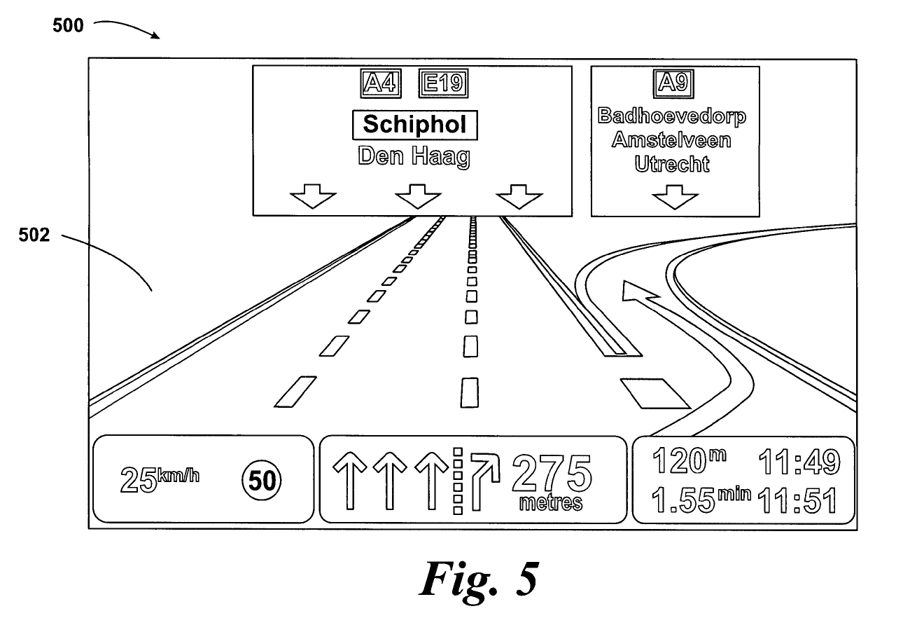

FIG. 5 illustrates an example of a display screenshot 500, for displaying a static image 502 of a location on an integrated input and display device 290 of a navigation device 200. When a navigation device 200 is being used, in a motor vehicle for example, it may be beneficial to display, for the user of the navigation device 200, images of certain locations along the determined route of travel. Such locations can include intersection between roads, highway exit and entrance ramps, merging traffic lanes, interchanges, cloverleaf configurations, flyovers, etc. Such can be accomplished by replacing the map information displayed on the integrated input and display device 290 with a static image 502 of such a location when the navigation device 200 is within a threshold distance of the location.

Such a static image 502 may be stored in memory 220 of the navigation device 200 for example. In addition, the threshold distance can be set and stored in the memory 220 of the navigation device 200 and the processor 210 can then determine, using a current location of the navigation device 200 (detectable from a GPS signal for example) and the location of the static image 502, when the navigation device 200 is within the threshold distance of the location.

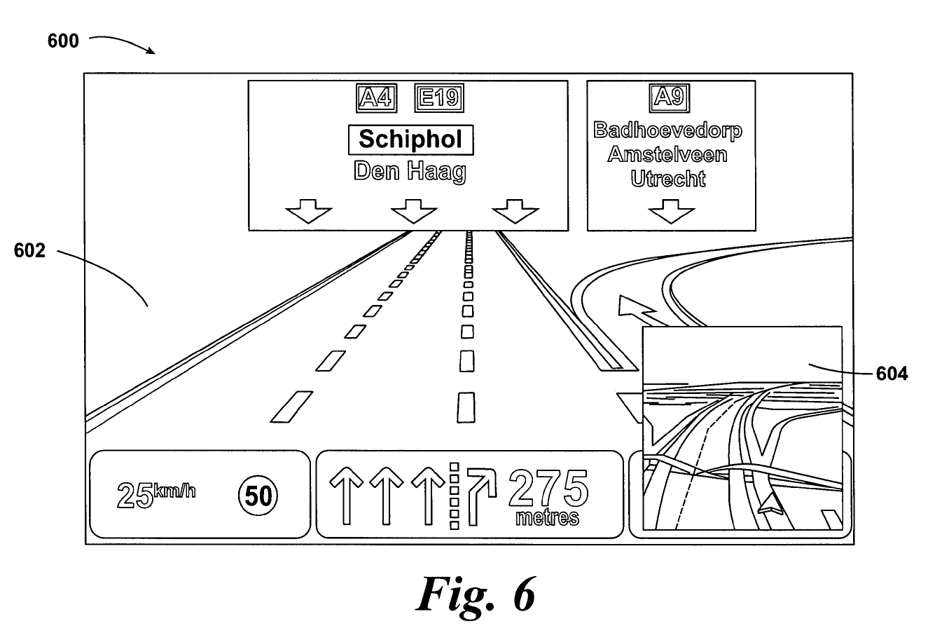

FIG. 6 illustrates an example embodiment of the present application and illustrates an example of a display screenshot 600, for display on an integrated input and display device 290 of a navigation device 200 for example.

Based upon a determined route of travel of the navigation device 200 (determined in a known manner using a current GPS location of the navigation device 200 and a user input or user selected final destination for example), map information is retrieved, by processor 210 for example, for display, on an integrated input and display device 290 for example. A route of travel of the navigation device 200 may be initially retrieved, by the processor 210 for example, upon input or selection of a desired travel destination and upon detection of a current location via a GPS signal for example, wherein determination of a route of travel from stored map information utilizing the current GPS location and input of selected travel designation can be done in a known manner by processor 210 for example.

The determined map information is then displayed on the integrated input and display device 290. The display may be a three dimensional representation and may be animated to show the location of the navigation device 200 as the navigation device 200 is moved. When the navigation device 200 is determined by processor 210 to be within a threshold distance of a location (including but not limited to an intersection, highway exit or entrance ramp, merging traffic lane, interchange, cloverleaf configuration, flyover, etc.) along the determined route of travel, a static image of the location is displayed on the integrated input and display device 290. As the processor 210 may be programmed with the “locations” and static images thereof (stored in memory 230 for example) and thus knows the position of the “locations” for which static images are stored, it can then determine when the navigation device 200 is within the threshold distance of a “location”, and thus when to display the static image of the location.

In such a situation where the processor 210 determines that the navigation device 200 is within the threshold distance of a “location” for which a static image is stored, unlike the display screenshot 500 in FIG. 5, the processor 210 may then control a static image 602 of the location to be displayed along with the map information display 604. The map information display may continue to be a three dimensional representation and may be updated to reflect the current position of the navigation device 200 as it continues to move. Thus the user is able to simultaneously view the upcoming location of interest (when within a threshold distance thereof) and the current location and map. The display on the integrated input and display device 290 may remain in this configuration for a period of time, and the navigation device 200 can then return to displaying the map information 604 without the static image 602 of the location.

The position and relative size of the static image 602 and the map information display 604 are not limited to those illustrated in FIG. 6. Both the static image 602 and the map information display 604 may be the same size and located beside or above one another. Alternatively, as illustrated in FIG. 6, one of the static image 602 and the map information display 604 may be larger than the other. Additionally, one of the static image 602 and the map information display 604 may overlie at least a portion of the other. For example, in FIG. 6 the static image 602 is larger than the map information display 604 and the map information display 604 overlies a portion of the static image 602 resulting in a “picture in picture” effect. Alternatively, the static image 602 could be the smaller image and could overlie a portion of the map information display 604.

The threshold distance from a location at which the static image 602 is displayed may be variable or fixed. The threshold distance may be a fixed distance, for example one kilometer before a location for which a static image is stored. Alternatively the threshold distance may be variable, including but not limited to a variable distance based on the speed at which the navigation device is moving, for example. In such a variable threshold distance embodiment, the user may be shown the static image 602 of the location the same amount of time before reaching the location, regardless of the speed that user is traveling.

Additionally, the transition from displaying only map information to displaying both the static image 602 and the map information display 604 may be accomplished numerous ways. The map information may simply be replaced, simultaneously, with the static image 602 and the map information display 604. Alternatively, the map information may be visually reduced in size and visually moved to a different position on the integrated input and display device 290. Similarly, the static image 602 may simply appear on the screen, fade in, pixelate in, increase from a single pixel, etc. Additionally, when changing the size and/or location of the static image 602 and/or the map information display 604 any of numerous complex transition effects, such as rotating, spinning, fading, flipping, peeling off, page turning, etc., can be used.

The embodiment of the present application discussed above included a navigation device 200 which is a portable navigation device. However, the embodiments, methods and devices explained above are not limited as such. Aspects, embodiments, methods and devices explained above are further applicable to a navigation device which is integrated into a vehicle. Such a navigation device may be, for example, integrated into a dashboard or other portion of a vehicle. Such a vehicle may include, but is not limited to a car, truck, boat, motorcycle, etc. In at least one embodiment, such a navigation device integrated in a vehicle may be used to perform the various aspects discussed above as would be understood by one of ordinary skill in the art. Thus, further explanation is omitted for the sake of brevity.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

The methods of at least one embodiment expressed above may be implemented as a computer data signal embodied in the carrier wave or propagated signal that represents a sequence of instructions which, when executed by a processor (such as processor 304 of server 302, and/or processor 210 of navigation device 200 for example) causes the processor to perform a respective method. In at least one other embodiment, at least one method provided above may be implemented above as a set of instructions contained on a computer readable or computer accessible medium, such as one of the memory devices previously described, for example, to perform the respective method when executed by a processor 210 or other computer device. In varying embodiments, the medium may be a magnetic medium, electronic medium, optical medium, etc.

As one of ordinary skill in the art will understand upon reading the disclosure, the electronic components of the navigation device 200 and/or the components of the server 302 can be embodied as computer hardware circuitry or as a computer readable program, or as a combination of both.

The system and method of embodiments of the present application include software operative on the processor to perform at least one of the methods according to the teachings of the present application. One of ordinary skill in the art will understand, upon reading and comprehending this disclosure, the manner in which a software program can be launched from a computer readable medium in a computer based system to execute the functions found in the software program. One of ordinary skill in the art will further understand the various programming languages which may be employed to create a software program designed to implement and perform at least one of the methods of the present application.

The programs can be structured in an object-orientation using an object-oriented language including but not limited to JAVA, Smalltalk, C++, etc., and the programs can be structured in a procedural-orientation using a procedural language including but not limited to COBAL, C, etc. The software components can communicate in any number of ways that are well known to those of ordinary skill in the art, including but not limited to by application of program interfaces (API), interprocess communication techniques, including but not limited to report procedure call (RPC), common object request broker architecture (CORBA), Component Object Model (COM), Distributed Component Object Model (DCOM), Distributed System Object Model (DSOM), and Remote Method Invocation (RMI). However, as will be appreciated by one of ordinary skill in the art upon reading the present application disclosure, the teachings of the present application are not limited to a particular programming language or environment.

The above systems, devices, and methods have been described by way of example and not by way of limitation with respect to improving accuracy, processor speed, and ease of user interaction, etc. with a navigation device 200.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method, comprising:
determining map information for display on an integrated input and display device of a navigation device, based upon a determined route of travel of the navigation device;
displaying the determined map information, in three dimensions on the integrated input and display device of the navigation device; and
displaying, along with the determined map information, a static image of a location along the determined route of travel on the integrated input and display device of the navigation device when the navigation device is determined to be within a threshold distance of the location.

2. The method of claim 1, wherein the static image of the location and the determined map information are displayed on the integrated input and display device without overlapping each other.

3. The method of claim 2, wherein the determined map information is displayed at a first size and the static image is displayed at a second size on the integrated input and display device.

4. The method of claim 1, wherein the displaying includes displaying the static image of the location at the first size and displaying the determined map information at the second size.

5. The method of claim 4, wherein the displaying includes displaying at least one of the determined map information and the static image of the location in a position on the integrated input and display device overlapping at least a portion of the other one of the determined map information and the static image.

6. The method of claim 4, wherein the displaying of the determined map information includes displaying, at some time, the determined map information at the first size.

7. The method of claim 6, further comprising transitioning from displaying the determined map information at the first size to displaying the determined map information at the second size when the navigation device is determined to be within the threshold distance of the location.

8. The method of claim 6, wherein the first size is relatively larger than the second size.

9. A computer readable medium including program segments for, when executed on a processor of the navigation device, causing the navigation device to implement the method of claim 1.

10. A navigation device, comprising:
a processor to determine map information for subsequent display, based upon a determined route of travel of the navigation device, and being useable to control display of the map information; and
an integrated input and display device to display the map information, the processor being further useable to control display of a static image of a location along the determined route of travel on the integrated input and display device simultaneously with the display of the map information when the navigation device is determined to be within a threshold distance of the location.

11. The navigation device of claim 10, wherein the control of display of the map information includes controlling a size of the display of the map information.

12. The navigation device of claim 11, wherein the control of display of the map information includes controlling a location on the integrated input and display device at which the map information is displayed.

13. The navigation device of claim 12, wherein the processor is configured to control of display to change at least one of the size and location of the display of the map information on the integrated input and display device when the static image is displayed on the integrated input and display device.

14. The navigation device of claim 10, wherein the control of display of the map information includes controlling a size of the display of the static image.

15. The navigation device of claim 14, wherein the control of display of the static image includes controlling a location on the integrated input and display device at which the static image is displayed.

16. The navigation device of claim 13, wherein the control of display of the map information includes controlling a size of the display of the static image.

17. The navigation device of claim 16, wherein the control of display of the static image includes controlling a location on the integrated input and display device at which the static image is displayed.

18. The navigation device of claim 10, wherein the navigation device is a portable navigation device.

19. The navigation device of claim 10, wherein the navigation device is integrated into a vehicle.
